(19) United States
(12) Patent Application Publication
(10) Pub. No.: US 2024/0415194 A1
(43) Pub. Date: Dec. 19, 2024

(54) AEROSOL GENERATING DEVICE AND CONTROLLING METHOD THEREOF

(71) Applicant: KT&G CORPORATION, Daejeon (KR)

(72) Inventors: Ju Eon PARK, Seongnam-si (KR); Tae Hun KIM, Yongin-si (KR); Youn Ji SHIN, Seoul (KR); Hun Il LIM, Seoul (KR); Hyung Jin JUNG, Seoul (KR)

(73) Assignee: KT&G CORPORATION, Daejeon (KR)

(21) Appl. No.: 18/743,468

(22) Filed: Jun. 14, 2024

(30) Foreign Application Priority Data
Jun. 16, 2023 (KR) 10-2023-0077516
Aug. 9, 2023 (KR) 10-2023-0104357

(51) Int. Cl. A24F 40/53; A24F 40/10; A24F 40/20; A24F 40/30; A24F 40/51; A24F 40/57; A24F 40/60; H05B 1/02

(52) U.S. Cl. CPC A24F 40/53; A24F 40/20; A24F 40/51; A24F 40/57; A24F 40/60; H05B 1/0227; A24F 40/10; A24F 40/30

(57) ABSTRACT

Provided is an aerosol generating device including at least one heater configured to heat an aerosol generating material, a power supply configured to supply power to the at least one heater, a load switch including a first terminal electrically connected to the power supply, a second terminal electrically connected to the at least one heater, and a third terminal configured to receive an enable signal turning on or off an electrical connection between the first terminal and the second terminal, a controller configured to control power supplied to the heater, and a protection circuit configured to monitor an electrical signal of the load switch and to output the enable signal to the third terminal.

### CROSS-REFERENCE TO RELATED APPLICATION

This application is based on and claims priority under 35 U.S.C. § 119 to Korean Patent Application Nos. 10-2023-0077516, filed on Jun. 16, 2023 and 10-2023-0104357, filed on Aug. 9, 2023, in the Korean Intellectual Property Office, the disclosures of which are incorporated by reference herein in their entirety.

### BACKGROUND

### 1. Field

The disclosure relates to an aerosol generating device and a controlling method thereof.

### 2. Description of the Related Art

Recently, the demand for alternative methods to overcome the shortcomings of general cigarettes has increased. For example, there is a growing demand for systems in which aerosols are generated by heating cigarettes or aerosol generating materials by using aerosol generating devices, rather than methods of generating aerosols by burning cigarettes. Accordingly, research on heating-type aerosol generating devices is actively conducted.

### SUMMARY

An aerosol generating device uses a heater for heating an aerosol generating material. When the heater malfunctions, user satisfaction with smoking may decrease, and the aerosol generating device may be damaged.

Thus, the aerosol generating device having the heater therein requires a technology for preventing malfunction of the heater.

Technical problems to be solved by the present embodiment are not limited to technical problems as described above, and other technical problems may be inferred from the following embodiments.

Additional aspects will be set forth in part in the description which follows and, in part, will be apparent from the description, or may be learned by practice of the presented embodiments of the disclosure.

According to an embodiment, an aerosol generating device may include at least one heater configured to heat an aerosol generating material, a power supply configured to supply power to the at least one heater, a load switch including a first terminal electrically connected to the power supply, a second terminal electrically connected to the at least one heater, and a third terminal configured to receive an enable signal turning on or off an electrical connection between the first terminal and the second terminal, a controller configured to control power supplied to the heater, and a protection circuit configured to monitor an electrical signal of the load switch and to output the enable signal to the third terminal.

According to another embodiment, a method of controlling an aerosol generating device, may include monitoring an electrical signal of a load switch, the load switch being configured to transmit power supplied from a power supply to a heater, and preventing an abnormal operation of the load switch.

### BRIEF DESCRIPTION OF THE DRAWINGS

The above and other aspects, features, and advantages of certain embodiments of the disclosure will be more apparent from the following description taken in conjunction with the accompanying drawings, in which:

FIGS. 1 through 3 are diagrams of an aerosol generating device according to embodiments;

FIG. 4 is a front perspective view of an aerosol generating device according to an embodiment;

FIG. 5 is a coupling perspective view of a body, a cartridge, and a cap of an aerosol generating device according to an embodiment;

FIG. 6 is a cross-sectional view of an aerosol generating device according to an embodiment;

FIG. 7 is a diagram of a stick according to an embodiment;

FIG. 8 is a block diagram of an aerosol generating device according to an embodiment;

FIG. 9 is a block diagram for describing an operation of a protection circuit according to an embodiment; and

FIG. 10 is a flowchart illustrating a method of controlling an aerosol generating device, according to an embodiment.

### DETAILED DESCRIPTION

The terms used in the embodiments are general terms that are currently widely used as much as possible while considering functions in the disclosure, but this may change depending on the intention or precedent of a person working in the art, the emergence of new technology, and so on. Also, in a certain case, there are terms randomly selected by the applicant, and in this case, the meaning is described in detail in the relevant description of the disclosure. Therefore, the terms used in the disclosure should be defined based on the meaning of the term and the overall content of the disclosure, rather than simply the name of the term.

When it is described that a portion “includes” a certain element throughout the specification, this means that, unless specifically stated to the contrary, the portion does not exclude other elements but may further include other elements. Also, a term, such as a “unit”, a “portion”, or a “module”, used in the specification refers to a unit that processes at least one function or operation, which may be implemented by hardware, software, or a combination of hardware and software.

As described herein, when an expression, such as “at least one” precedes arranged elements, the expression modifies all of the arranged elements rather than each of the arranged elements. For example, an expression “at least one of a, b, and c” should be interpreted to include a, b, c, a and b, a and c, b and c, or a and b and c.

In one embodiment, an aerosol generating device may generate an aerosol by electrically heating a stick accommodated in an internal space of the aerosol generating device.

The aerosol generating device may include a heater. In one embodiment, the heater may be an electrically resistive heater. For example, a heater may include an electroconductive track, and the heater may be heated when a current flows through the electroconductive track.

The heater may include a tube-shaped heating element, a plate-shaped heating element, a needle-shaped heating element, or a rod-shaped heating element and may heat the inside or outside of the stick depending on shapes of heating elements.

The stick may include a tobacco rod and a filter rod. The tobacco rod may be made of a sheet, a strand, or cut fillers obtained by finely cutting a tobacco sheet. Also, the tobacco rod may be surrounded by a heat-conducting material. For example, the heat-conducting material may be a metal foil, such as aluminum foil, but is not limited thereto.

The filter rod may be a cellulose acetate filter. The filter rod may include at least one segment. For example, the filter rod may include a first segment that cools an aerosol and a second segment that filters certain components included in the aerosol.

In another embodiment, an aerosol generating device may generate an aerosol by using a cartridge including an aerosol generating material.

The aerosol generating device may include a cartridge holding an aerosol generating material and a main body supporting the cartridge. The cartridge may be detachably coupled to the main body but is not limited thereto. The cartridge may be formed or assembled integrally with the main body and may also be fixed so as not to be attached or detached by a user. The cartridge may be mounted on the main body while including an aerosol generating material therein. However, the disclosure is not limited thereto, and an aerosol generating material may also be injected into the cartridge while the cartridge is coupled to the main body.

The cartridge may include an aerosol generating material in any one of various states, such as a liquid state, a solid state, a gas state, and a gel state. An aerosol generating material may include a liquid composition. For example, the liquid composition may include a tobacco-containing material, including volatile tobacco flavor components or may include a non-tobacco material.

The cartridge is operated by an electric signal or wireless signal transmitted from the main body, thereby converting a phase of the aerosol generating material in the cartridge into a gas phase to generate an aerosol. An aerosol may refer to a gas in a state in which the vaporized particles generated from an aerosol generating material are mixed with air.

In another embodiment, an aerosol generating device may heat a liquid composition to generate an aerosol, and the generated aerosol may be transferred to a user through a stick. That is, the aerosol generated from the liquid composition may move along an airflow path of the aerosol generating device, and the airflow path may be configured to allow an aerosol to pass through the stick and be transferred to a user.

In another embodiment, an aerosol generating device may generate an aerosol from an aerosol generating material by using an ultrasonic vibration method. In this case, the ultrasonic vibration method may refer to a method of generating an aerosol by atomizing an aerosol generating material with ultrasonic vibration generated by a vibrator.

The aerosol generating device may include a vibrator and generate short-cycle vibration through the vibrator to atomize an aerosol generating material. The vibration generated by the vibrator may be ultrasonic vibration, and a frequency bandwidth of the ultrasonic vibration may be from about 100 kHz to about 3.5 MHz but is not limited thereto.

The aerosol generating device may further include a wick that absorbs an aerosol generating material. For example, the wick may surround at least one region of a vibrator or may be in contact with at least one region of the vibrator.

As a voltage (for example, an alternating current (AC) voltage) is applied to the vibrator, heat and/or ultrasonic vibration may be generated by the vibrator, and the heat and/or ultrasonic vibration generated by the vibrator may be transferred to an aerosol generating material absorbed into the wick. The aerosol generating material absorbed into the wick may be converted into a gas phase by heat and/or ultrasonic vibration transferred from the vibrator, and as a result, an aerosol may be generated.

For example, the viscosity of an aerosol generating material absorbed into the wick may be reduced by the heat generated by the vibrator, and the aerosol generating material with the reduced viscosity due to the ultrasonic vibration generated by the vibrator may be converted into fine particles, and thereby, an aerosol may be generated but is not limited thereto.

In another embodiment, an aerosol generating device may generate an aerosol by heating an aerosol generating article accommodated in the aerosol generating device by using an induction heating method.

The aerosol generating device may include a susceptor and a coil. In one embodiment, the coil may apply a magnetic field to the susceptor. As power is supplied to the coil from the aerosol generating device, a magnetic field may be formed inside the coil. In one embodiment, the susceptor may be a magnetic body that generates heat by an external magnetic field. As the susceptor is inside the coil and a magnetic field is applied to the susceptor to cause the susceptor to generate heat, an aerosol generating article may be heated. Also, the susceptor may be selectively placed inside the aerosol generating article.

In another embodiment, the aerosol generating device may further include a cradle.

The aerosol generating device may constitute a system with a separate cradle. For example, the cradle may charge a battery of the aerosol generating device. Also, a heater may be heated in a state where the cradle is coupled to the aerosol generating device.

Hereinafter, embodiments are described in detail with reference to the attached drawings such that those skilled in the art may easily implement the embodiments. The disclosure may be implemented in a form that may be implemented by aerosol generating devices according to various embodiments described above or may be implemented in a variety of different forms and is not limited to the embodiments described herein.

Hereinafter, embodiments are described in detail with reference to the drawings.

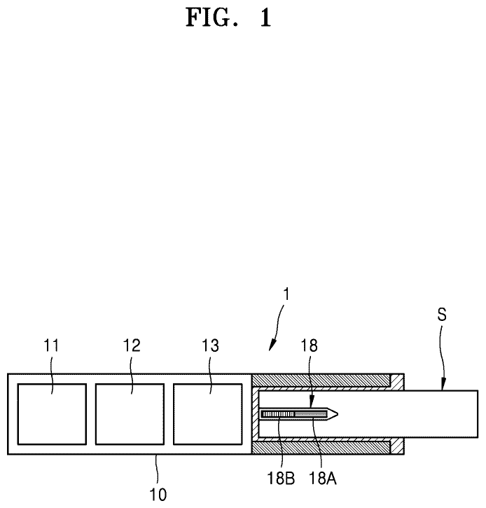

FIGS. 1 through 3 are diagrams of an aerosol generating device according to embodiments.

Referring to FIG. 1, the aerosol generating device according to embodiments may include at least one of a power supply 11, a controller 12, a sensor 13, and a heater 18. At least one of the power supply 11, the controller 12, the sensor 13, and the heater 18 may be arranged inside a body 10 of the aerosol generating device. The body 10 may provide a space opened upward so that a stick S that is an aerosol generating article may be inserted into the space. The upwardly-opened space may be referred to as an insertion space. The insertion space may be recessed to a certain depth toward an inside of the body 10, so that at least a part of the stick S may be inserted into the insertion space. A depth of the insertion space may correspond to a length of a region of the stick S in which the aerosol generating material and/or a medium is included. A lower end of the stick S may be inserted into the body 10, and an upper end of the stick S may protrude toward an outside of the body 10. A user may inhale the air by biting the upper end of the stick S exposed to the outside.

The heater 18 may heat the stick S. The heater 18 may extend long upward in the space into which the stick S is inserted. For example, the heater 18 may include a tube-shaped heating element, a plate-shaped heating element, a needle-shaped heating element, or a rod-shaped heating element. The heater 18 may be inserted into a lower part of the stick S. The heater 18 may include an electric resistive heater and/or an induction heating heater.

For example, the heater 18 may include an electric conductive track, and the heater 18 may be heated as a current flows through the electric conductive track. The heater 18 may be electrically connected to the power supply 11. The heater 18 may generate heat directly by receiving the current from the power supply 11.

For example, the heater 18 may be a multiple heater. The heater 18 may include a first heater 18A and a second heater 18B. The first and second heaters 18A and 18B may be arranged in parallel in a longitudinal direction. The first and second heaters 18A and 18B may be sequentially heated or may also be simultaneously heated.

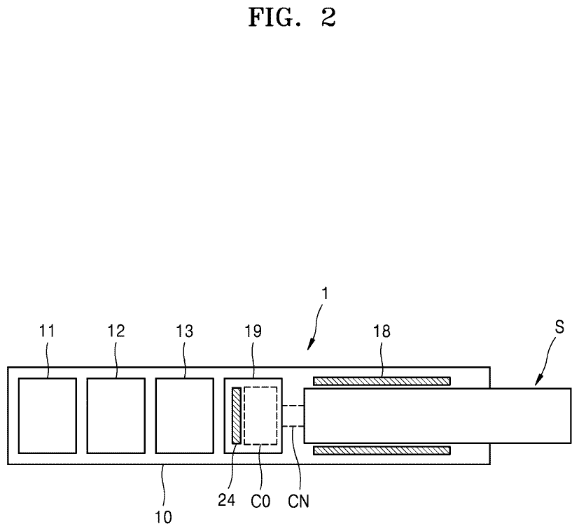

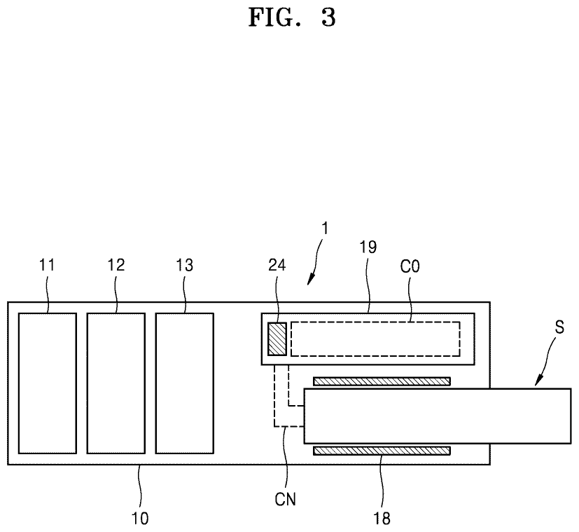

Referring to FIGS. 2 and 3, the aerosol generating device 1 may include at least one of a power source 11, a controller 12, a sensor 13, a heater 18, and a cartridge 19. At least one of the power source 11, the controller 12, the sensor 13, and the heater 18 may be arranged inside a body 10 of the aerosol-generating device 1. The body 10 may provide a space opened upwards so that a stick S, which is an aerosol generating article, is inserted thereinto. The space opened upwards may be referred to as an insertion space. The insertion space may be formed by being recessed toward the inside of the body 10 by a certain depth so that at least a portion of the stick S may be inserted thereinto. The depth of the insertion space may correspond to a length of a region in the stick S, which includes an aerosol generating material and/or a medium. A lower end of the stick S may be inserted into the body 10, and an upper end of the stick S may protrude to the outside of the body 10. A user may inhale air by holding, in the mouth, the upper end of the stick S exposed to the outside.

The heater 18 may heat the stick S. The heater 18 may extend long upwards around a space into which the stick S is inserted. For example, the heater 18 may be in the form of a tube including a hollow therein. The heater 18 may be arranged around the insertion space. The heater 18 may be arranged to surround at least a portion of the insertion space. The heater 18 may heat the insertion space or the stick S inserted into the insertion space. The heater 18 may include an electrically resistive heater and/or an induction heater.

For example, the aerosol generating device 1 may include an induction coil surrounding the heater 18. The induction coil may generate heat in the heater 18. The heater 18 may be a susceptor, and the heater 18 may generate heat by a magnetic field generated by an AC current flowing through the induction coil. The magnetic field may pass through the heater 18 and generate an eddy current within the heater 18. The current may generate heat in the heater 18.

Meanwhile, a susceptor may be included inside the stick S, and the susceptor inside the stick S may generate heat by the magnetic field generated by the AC current flowing through the induction coil.

The cartridge 19 may contain an aerosol generating material in any one of a liquid state, a solid state, a gaseous state, a gel state, and the like. The aerosol generating material may include a liquid composition. For example, the liquid composition may be a liquid including a tobacco-containing material having a volatile tobacco flavor component, or a liquid including a non-tobacco material.

The cartridge 19 may be integrally formed with the body 10 or detachably coupled to the body 10.

For example, referring to FIG. 2, the cartridge 19 may be integrally formed with the body 10 and may communicate with the insertion space through an air flow channel CN.

For example, referring to FIG. 3, a space may be formed in one side of the body 10, and at least a portion of the cartridge 19 may be inserted into the space formed in one side of the body 10, so that the cartridge 19 may be mounted in the body 10. The air flow channel CN may be defined by a portion of the cartridge 19 and/or a portion of the body 10, and the cartridge 19 may communicate with the insertion space through the air flow channel CN.

The body 10 may be formed in a structure in which external air may be introduced into the body 10 while the cartridge 19 is inserted the body 10. Here, the external air introduced into the body 10 may pass through the cartridge 19 and flow into the mouth of the user.

The cartridge 19 may include a storage CO containing the aerosol generating material and/or a heater 24 heating the aerosol generating material in the storage CO. A liquid delivery element impregnated with (containing) the aerosol generating material may be arranged inside the storage CO. Here, the liquid delivery element may include a wick or the like such as a cotton fiber, a ceramic fiber, a glass fiber, or porous ceramic. An electrically conductive track of the heater 24 may be formed in a coil-shaped structure that is wound around the liquid delivery element or in a structure in contact with one side of the liquid delivery element. The heater 24 may be referred to as a cartridge heater 24.

The cartridge 19 may generate an aerosol. When the liquid delivery element is heated by the cartridge heater 24, an aerosol may be generated. The aerosol may be generated by heating the stick S by the heater 18. While the aerosol generated by the cartridge heater 24 and the heater 18 passes through the stick S, a tobacco material may be added to the aerosol, and the aerosol having the tobacco material added thereto may be inhaled into the mouth of the user through one end of the stick S.

The aerosol generating device 1 may include only the cartridge heater 24 and may not include the heater 18 in the body 10. Here, the aerosol generated by the cartridge heater 24 may have the tobacco material added thereto while passing through the stick S and may be inhaled into the mouth of the user.

The aerosol generating device 1 may include a cap (not shown). The cap may be detachably coupled to the body 10 to cover at least a portion of the cartridge 19 coupled to the body 10. The stick S may pass through the cap and be inserted into the body 10.

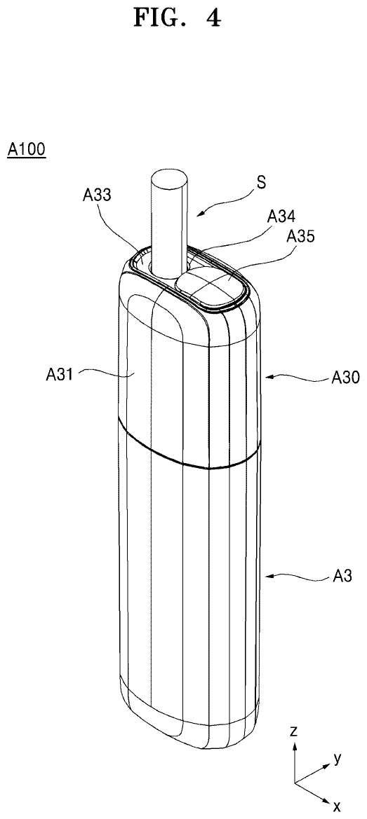

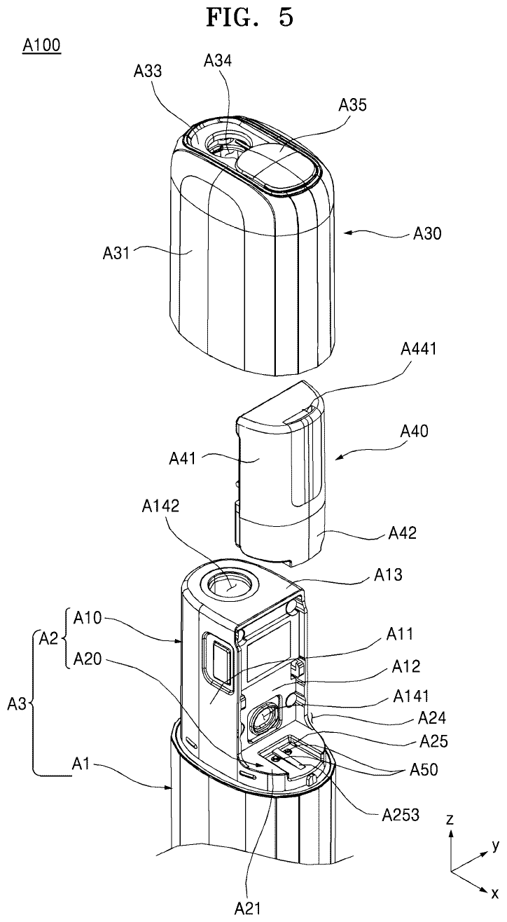

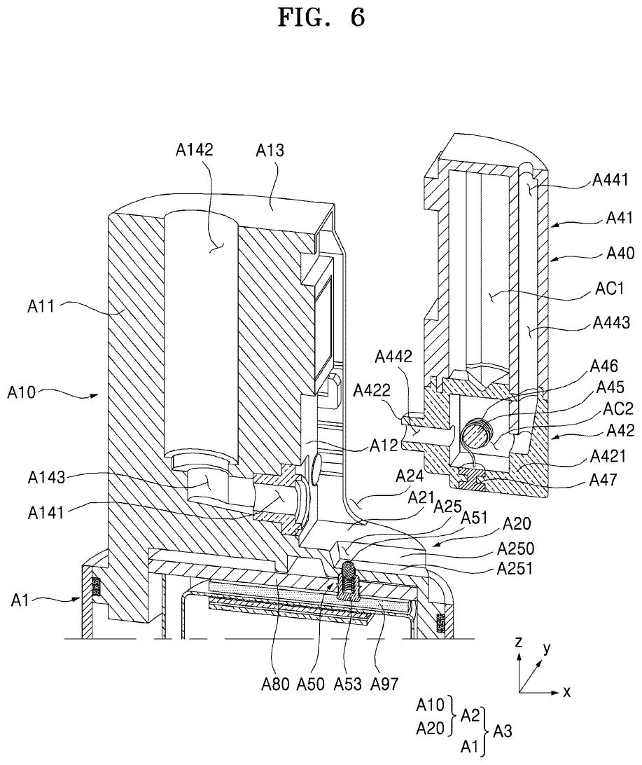

FIG. 4 is a front perspective view of an aerosol generating device according to an embodiment, FIG. 5 is a combined perspective view of a body, a cartridge, and a cap of an aerosol generating device according to an embodiment, and FIG. 6 is a cross-sectional view of an aerosol generating device according to an embodiment.

Referring to FIG. 4, an aerosol generating device A100 according to an embodiment may include a body A3. The aerosol generating device A100 may include a cap A30. The aerosol generating device A100 may include a cartridge A40. The cartridge A40 may be detachably coupled to one side of the body A3. The cap A30 may be detachably coupled to the body A3 to cover the cartridge A40. A stick S may pass through the cap A30 and be inserted into the body A3.

Referring to FIG. 5, the body A3 may include a lower body A1 and an upper body A2. Components of the aerosol generating device A100, such as a battery and a controller, may be installed inside the lower body A1. The upper body A2 may be coupled to an upper side of the lower body A1.

The upper body A2 may include a column A10 and a seating portion A20. The column A10 may extend long in a vertical direction. The column A10 may include an outer wall A11, an inner wall A12, and an upper wall A13.

The seating portion A20 may protrude from a lower portion of the inner wall A12 of the column A10. The seating portion A20 may face an upper side. A cartridge area A24 may be formed between the inner wall A12 of the column A10 and the seating portion A20. The cartridge area A24 may be located on one side of the inner wall A12 of the column A10 and may be located above the seating portion A20.

The column A10 may include an insertion space A142. The insertion space A142 may extend in the vertical direction inside the column A10 and may be opened upwards so that the upper wall A13 is opened.

A body inlet A141 may be formed in one side of the column A10. The body inlet A141 may be formed by opening the inner wall A12. The body inlet A141 may be opened to the outside of the column A10. The body inlet A141 may communicate with the insertion space A142. The body inlet A141 may be arranged to face the cartridge area A24. The body inlet A141 may communicate with the cartridge area A24.

The cartridge A40 may be detachably coupled to the upper body A2 in the cartridge area A24. The cartridge A40 may be coupled to the inner wall A12 of the column A10 and may be seated on the seating portion A20 so that a bottom thereof is supported. The cartridge A40 may include a first container A41 and a second container A42. The first container A41 may be arranged on an upper side of the second container A42. The first container A41 may store a liquid.

The cap A30 may cover the upper body A2 and may be detachably coupled to the body A3. The cap A30 may cover the upper body A2 and the cartridge A40 coupled to the upper body A2. The cap A30 may have formed therein a space into which the upper body A2 and the cartridge A40 are inserted. The space inside the cap A30 may be opened downwards. A sidewall A31 of the cap A30 may surround a side portion of the space inside the cap A30. An upper wall A33 of the cap A30 may cover an upper portion of the space inside the cap A30. An insertion hole A34 may be formed by opening the upper wall A33. When the cap A30 is coupled to the body A3, the insertion hole A34 may communicate with the insertion space A142 above the insertion space A142. A cover A35 may be movably installed on the upper wall A33. The cover A35 may slide on the upper wall A33. The cover A35 may open and close the insertion hole A34.

Referring to FIG. 6, a first chamber AC1 may be formed inside the first container A41. A liquid may be stored in the first chamber AC1. A second chamber AC2 may be formed inside the second container A42.

A cartridge inlet A441 may be formed by opening the cartridge A40. A cartridge outlet A442 may be formed by opening the cartridge A40. A cartridge flow path A443 may connect the cartridge inlet A441 to the second chamber AC2. The cartridge outlet A442 may communicate with the second chamber AC2.

The cartridge outlet A442 may be formed by opening one side of the second container A42. A discharge port A422 may surround the cartridge discharge outlet A442. The discharge port A422 may protrude from one side of the second container A42. When the cartridge A40 is coupled to the upper body A2, the discharge port A422 may be inserted into the body inlet A141, and the cartridge outlet A442 and the body inlet A141 may communicate with each other.

A wick A45 may be installed in the second chamber AC2. The wick A45 may be connected to the first chamber AC1. The wick A45 may be supplied with a liquid from the first chamber AC1. A heater A46 may generate heat and heat the wick A45. The heater A46 may be arranged in the second chamber AC2. The heater A46 may be wound around the wick A45. When the heater A46 heats the wick A45, an aerosol may be generated around the wick A45 in the second chamber AC2.

A heater terminal A47 may be exposed to a lower portion of the cartridge A40. The heater terminal A47 may be formed at a bottom of the second container A42. The heater terminal A47 may be electrically connected to the heater A46. When the cartridge A40 is coupled to the upper body A2, the heater terminal A47 may be in contact with and electrically connected to a first pin A50. Here, the heater terminal A47 may be referred to as a second pin A47.

The first pin A50 may protrude to the outside of the seating portion A20. The first pin A50 may be supplied with power from a battery installed inside the lower body A1 through a connector A97 and provide the power to the heater terminal A47 and the heater A46. The heater A46 may be supplied with power and generate heat.

Air outside the cartridge A40 may be introduced into the cartridge A40 through the cartridge inlet A441. The air may sequentially flow through the cartridge inlet A441, the cartridge flow path A443, the second chamber AC2, and the cartridge outlet A442. Air inside the cartridge A40 may be discharged to the outside of the cartridge A40 through the cartridge outlet A442. The air introduced into the cartridge A40 may be accompanied by an aerosol generated in the second chamber AC2 and discharged to the outside of the cartridge A40 through the cartridge outlet A442.

The first pin A50 may be arranged inside the body A3 and may protrude to the outside of the body A3. The body A3 may include the seating portion A20.

The seating portion A20 may have an outer recessed groove A25. The outer recessed groove A25 may be formed by recessing an upper surface A21 of the seating portion A20 downwards. The outer recessed groove A25 may be located below the cartridge area A24. The upper surface A21 of the seating portion A20 may be referred to as an outer surface of the body A3. The outer recessed groove A25 may be formed in the outer surface of the body A3.

A lower portion of the outer recessed groove A25 may be covered with a bottom portion A251, and a side portion of the outer recessed groove A25 may be covered with a circumferential portion A252. An upper side of the outer recessed groove A25 may be opened. One side portion of the outer recessed groove A25 may be opened without being covered with the circumferential portion A252. When an x direction indicated in a coordinate system is defined as the front, the front of the outer recessed groove A25 may be opened. An upper end of the first pin A50 may convexly protrude or be exposed upwards from the bottom portion A251 of the outer recessed groove A25 toward the outer recessed groove A25.

The bottom of the cartridge A40 may have a shape corresponding to the seating portion A20 and the outer recessed groove A25. When the cartridge A40 is coupled to the upper body A2, the bottom of the cartridge A40 may be seated on the seating port A20, and the first pin A50 and the second pin A47 may be electrically connected to each other.

A plurality of guide portions A253 may be provided. The guide portion A253 may extend long from the front to the rear. The guide portion A253 may be formed to be inclined and gradually become higher from the front to the rear. Each of the plurality of guide portions A253 may be arranged in front of each of a plurality of first pins A50. A height of a rear end of the guide portion A253 adjacent to the first pin A50 may be the same as or similar to a height of the first pin A50.

Accordingly, when the cartridge A40 is coupled to the upper body A2, the guide portion A253 may guide the arrangement of the cartridge A40 so that the first pin A50 and the second pin A47 contact each other.

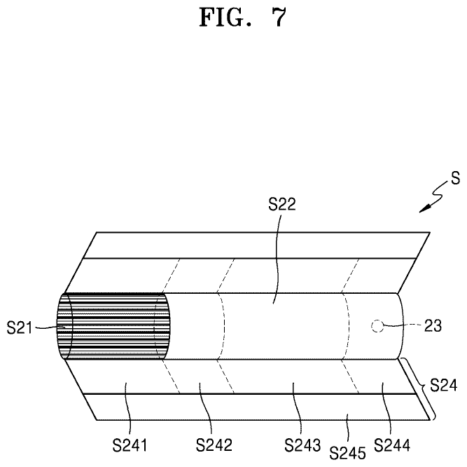

FIG. 7 illustrate examples of stick.

Referring to FIG. 7, the stick S may include a tobacco rod S21 and a filter rod S22.

FIG. 7 illustrates that the filter rod S22 includes a single segment. However, the filter rod S22 is not limited thereto. In other words, the filter rod S22 may include a plurality of segments. For example, the filter rod S22 may include a first segment configured to cool an aerosol and a second segment configured to filter a certain component included in the aerosol. Also, according to necessity, the filter rod S22 may further include at least one segment configured to perform other functions.

The diameter of the stick S may be within the range of about 5 mm to about 9 mm and the length of the stick S may be about 48 mm. However, the disclosure is not limited thereto. For example, the length of the tobacco rod S21 may be about 12 mm, the length of the first segment of the filter rod S22 may be about 10 mm, the length of the second segment of the filter rod S22 may be about 14 mm, and the length of the third segment of the filter rod S22 may be about 12 mm. However, disclosure is not limited thereto.

The stick S may be packaged via at least one wrapper S24. The wrapper S24 may have at least one hole through which external air may be introduced or internal air may be discharged. For example, the stick S may be packaged via one wrapper S24. As another example, the stick S may be doubly packaged via at least two wrappers S24. For example, the tobacco rod S21 may be packaged via a first wrapper S241, and the filter rod S22 may be packaged via second wrappers S242, S243, and S244. Also, the entire stick S may be packaged via a single wrapper S245. When the filter rod S22 includes a plurality of segments, each segment may be packaged via each of the second wrappers S242, S243, and S244.

The first wrapper S241 and the second wrapper S242 may each include general filter wrapping paper. For example, the first wrapper S241 and the second wrapper S242 may each include porous wrapping paper or non-porous wrapping paper. In addition, the first wrapper S241 and the second wrapper S242 may each include paper having oil resistance and/or an aluminum laminate packaging material.

The third wrapper SS243 may include hard wrapping paper. For example, the basis weight of the third wrapper SS243 may be in the range of about 88 g/m2 to about 96 g/m2, specifically in the range of about 90 g/m2 to about 94 g/m2. In addition, the thickness of the third wrapper SS243 may be in the range of about 120 μm to about 130 um, specifically 125 um.

The fourth wrapper S244 may include oil-resistant hard wrapping paper. For example, the basis weight of the fourth wrapper S244 may be in the range of about 88 g/m2 to about 96 g/m2, specifically in the range of about 90 g/m2 to about 94 g/m2. In addition, the thickness of the fourth wrapper S244 may be in the range of about 120 μm to about 130 um, specifically 125 um.

The fifth wrapper S245 may include sterile paper (MFW). Here, the sterile paper (MFW) refers to a paper specially prepared so that tensile strength, water resistance, smoothness, etc. thereof are further improved compared to those of general paper. For example, the basis weight of the fifth wrapper S245 may be in the range of about 57 g/m2 to about 63 g/m2, specifically 60 g/m2. In addition, the thickness of the fifth wrapper S245 may be in the range of about 64 μm to about 70 um, specifically 67 um.

A certain material may be internally added to the fifth wrapper S245. Here, an example of the certain material may include silicon, but is not limited thereto. For example, silicon has characteristics, such as heat resistance with little change with temperature, resistance to oxidation, resistance to various chemicals, water repellency against water, or electrical insulation. However, even though the certain material is not silicon, any material having the characteristics described above may be applied to (or coated on) the fifth wrapper S245 without limitation.

The fifth wrapper S245 may prevent the stick S from burning. For example, when the tobacco rod S21 is heated by the heater 13, there is a possibility that the stick S is burned. Specifically, when the temperature rises above the ignition point of any one of the materials included in the tobacco rod S21, the stick S may be burned. Even in this case, because the fifth wrapper S245 includes a non-combustible material, a burning phenomenon of the stick S may be prevented.

In addition, the fifth wrapper S245 may prevent a holder 1 from being contaminated by substances generated in the stick S. By a user's puff, liquid substances may be generated in the stick S. For example, as an aerosol generated in the stick S is cooled by the outside air, liquid substances (e.g., moisture, etc.) may be generated. As the fifth wrapper S245 wraps the stick S, the liquid substances generated in the stick S may be prevented from leaking out of the stick S.

The tobacco rod S21 includes an aerosol generating material. For example, the aerosol generating material may include at least one of glycerin, propylene glycol, ethylene glycol, dipropylene glycol, diethylene glycol, triethylene glycol, tetraethylene glycol, and oleyl alcohol, but it is not limited thereto. Also, the tobacco rod S21 may include other additives, such as flavors, a wetting agent, and/or organic acid. Also, the tobacco rod S21 may include a flavored liquid, such as menthol or a moisturizer, which is injected to the tobacco rod S21.

The tobacco rod S21 may be formed in various ways. For example, the tobacco rod S21 may be formed as a sheet or a strand. Also, the tobacco rod S21 may be formed as a pipe tobacco, which is formed of tiny bits cut from a tobacco sheet. Also, the tobacco rod S21 may be surrounded by a heat conductive material. For example, the heat-conducting material may be, but is not limited to, a metal foil such as aluminum foil. For example, the heat conductive material surrounding the tobacco rod S21 may uniformly distribute heat transmitted to the tobacco rod S21, and thus, the heat conductivity applied to the tobacco rod S21 may be increased and taste of the tobacco may be improved. Also, the heat conductive material surrounding the tobacco rod S21 may function as a susceptor heated by the induction heater. Here, although not illustrated in the drawings, the tobacco rod S21 may further include an additional susceptor, in addition to the heat conductive material surrounding the tobacco rod S21.

The filter rod S22 may include a cellulose acetate filter. Shapes of the filter rod S22 are not limited. For example, the filter rod S22 may include a cylinder-type rod or a tube-type rod having a hollow inside. Also, the filter rod S22 may include a recess-type rod. When the filter rod S22 includes a plurality of segments, at least one of the plurality of segments may have a different shape.

The first segment of the filter rod S22 may include a cellulose acetate filter. For example, the first segment may include a tube-shaped structure including a hollow therein. When the heater 13 is inserted by the first segment, the inner material of the tobacco rod S21 may be prevented from being pushed back, and a cooling effect of the aerosol may occur. The diameter of the hollow included in the first segment may be an appropriate diameter within the range of about 2 mm to about 4.5 mm, but is not limited thereto.

The length of the first segment may be an appropriate length within the range of about 4 mm to about 30 mm, but is not limited thereto. Specifically, the length of the first segment may be 10 mm, but is not limited thereto.

The hardness of the first segment may be adjusted by adjusting the content of a plasticizer in the manufacture of the first segment. In addition, the first segment may be manufactured by inserting a structure, such as a film or a tube including the same material or different materials, inside the first segment (e.g., into the hollow).

The second segment of the filter rod S22 cools the aerosol generated as the heater 13 heats the tobacco rod S21. Thus, a user may inhale the aerosol cooled to a suitable temperature.

The length or diameter of the second segment may be variously determined according to the shape of the stick S. For example, the length of the second segment may be appropriately determined within the range of about 7 mm to about 20 mm. Specifically, the length of the second segment may be about 14 mm, but is not limited thereto.

The second segment may be fabricated by weaving polymer fibers. In this case, a flavored liquid may be applied to fibers made of polymer. Alternatively, the second segment may be fabricated by weaving a fiber to which a flavored liquid is applied and a fiber made of a polymer together. Alternatively, the second segment may be formed by a crimped polymer sheet.

For example, the polymer may include a material selected from the group consisting of polyethylene (PE), polypropylene (PP), polyvinyl chloride (PVC), polyethylene terephthalate (PET), polylactic acid (PLA), cellulose acetate (CA), and aluminum foil.

As the second segment is formed by a woven polymer fiber or crimped polymer sheet, the second segment may include a single channel or a plurality of channels extending in a longitudinal direction thereof. Here, the channel refers to a passage through which a gas (e.g., air or aerosol) passes.

For example, the second segment formed by the crimped polymer sheet may be formed from a material having a thickness between about 5 μm and about 300 μm, such as between about 10 μm and about 250 um. Also, the total surface area of the second segment may be between about 300 mm2/mm and about 1000 mm2/mm. Furthermore, an aerosol cooling element may be formed from a material having a specific surface area between about 10 mm2/mg and about 100 mm2/mg.

The second segment may include a thread containing a volatile flavor ingredient. Here, the volatile flavor ingredient may be menthol, but is not limited thereto. For example, the thread may be filled with a sufficient amount of menthol to provide 1.5 mg or more of menthol to the second segment.

The third segment of the filter rod S22 may include a cellulose acetate filter. The length of the third segment may be appropriately determined within the range of about 4 mm to about 20 mm. For example, the length of the third segment may be about 12 mm, but is not limited thereto.

The third segment may be fabricated such that flavor is generated by spraying a flavored liquid on the third segment in the process of fabricating the third segment. Alternatively, a separate fiber to which a flavored liquid is applied may be inserted into the third segment. The aerosol generated by the tobacco rod S21 is cooled as the aerosol passes through the second segment of the filter rod S22, and the cooled aerosol is delivered to a user through the third segment. Accordingly, when a flavoring element is added to the third segment, an effect of enhancing the durability of a flavor delivered to the user may occur.

Also, the filter rod S22 may include at least one capsule 23. Here, the capsule S23 may generate a flavor or an aerosol. For example, the capsule S23 may have a configuration in which a liquid containing a flavoring material is wrapped with a film. For example, the capsule S23 may have a spherical or cylindrical shape, but is not limited thereto.

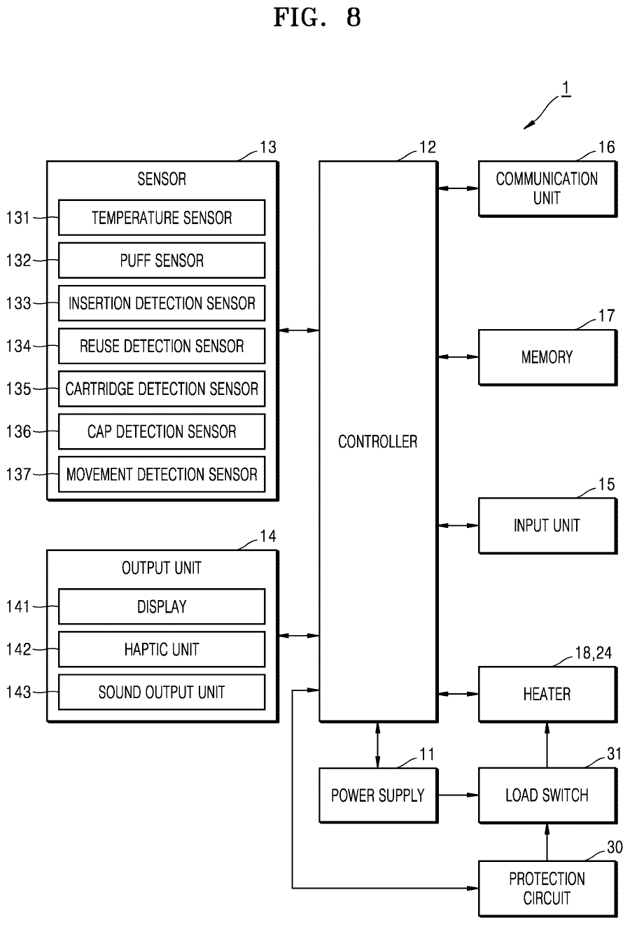

FIG. 8 is a block diagram of an aerosol generating device 1 according to an embodiment.

The aerosol generating device 1 may include a power supply 11, a controller 12, a sensor 13, an output unit 14, an input unit 15, a communication unit 16, memory 17, at least one heater 18, 24, a protection circuit 30, and a load switch 31. However, an internal structure of the aerosol generating device 1 is not limited to that illustrated in FIG. 8. In other words, according to the design of the aerosol generating device 1, one of ordinary skill in the art related to the present embodiment that some of the components shown in FIG. 8 may be omitted or new components may be added.

The sensor 13 may detect a state of the aerosol generating device 1 or a state around the aerosol generating device 1 and transmit detected information to the controller 12. On the basis of the detected information, the controller 12 may control the aerosol generating device 1 to perform various functions such as control of operations of the cartridge heater 24 and/or the heater 18, a restriction on smoking, determination of whether or not the stick S and/or the cartridge 19 are inserted, and a notification display.

The sensor 13 may include at least one of a temperature sensor 131, a puff sensor 132, an insertion detection sensor 133, a reuse detection sensor 134, a cartridge detection sensor 135, a cap detection sensor 136, and a motion detection sensor 137.

The temperature sensor 131 may detect a temperature at which the cartridge heater 24 and/or the heater 18 are heated. The aerosol generating device 1 may include a separate temperature sensor for detecting the temperatures of the cartridge heater 24 and/or the heater 18, or the cartridge heater 24 and/or the heater 18 may operate as temperature sensors.

The temperature sensor 131 may output a signal corresponding to the temperature of the cartridge heater 24 and/or the heater 18. For example, the temperature sensor 131 may include a resistor element whose resistance value changes in correspondence to a change in the temperature of the cartridge heater 24 and/or the heater 18. The temperature sensor 131 may be implemented by a thermistor or the like, which is an element using a property of changing resistance according to temperature. Here, the temperature sensor 131 may output a signal corresponding to the resistance value of the resistor element as a signal corresponding to the temperature of the cartridge heater 24 and/or the heater 18. For example, the temperature sensor 131 may include a sensor that detects a resistance value of the cartridge heater 24 and/or the heater 18. Here, the temperature sensor 131 may output a signal corresponding to the resistance value of the cartridge heater 24 and/or the heater 18 as a signal corresponding to the temperature of the cartridge heater 24 and/or the heater 18.

The temperature sensor 131 may be arranged around the power source 11 to monitor a temperature of the power source 11. The temperature sensor 131 may be arranged adjacent to the power source 11. For example, the temperature sensor 131 may be attached to one surface of a battery that is the power source 11. For example, the temperature sensor 131 may be mounted on one surface of a PCB.

The temperature sensor 131 may be arranged inside the body 10 to detect an internal temperature of the body 10.

The puff sensor 132 may detect a puff by a user on the basis of various physical changes in an air flow path. The puff sensor 132 may detect a puff by a user on the basis of various physical changes in an air flow path. For example, the puff sensor 132 may detect the puff by the user on the basis of any one of temperature change, flow change, voltage change, and pressure change in the airflow path. The puff sensor 132 may output a signal corresponding to the puff. For example, the puff sensor 132 may be a pressure sensor. The puff sensor 132 may output a signal corresponding to internal pressure of the aerosol generating device 1. Here, the internal pressure of the aerosol generating device 1 may correspond to pressure of the air flow path through which a gas flows. The puff sensor 132 may be arranged in correspondence to the air flow path through which the gas flows in the aerosol generating device 1.

The insertion detection sensor 133 may detect insertion and/or removal of the stick S. The insertion detection sensor 133 may detect a signal change due to the insertion and/or removal of the stick S. The insertion detection sensor 133 may be installed around an insertion space. The insertion detection sensor 133 may detect the insertion and/or removal of the stick S according to a change in a dielectric constant inside the insertion space. For example, the insertion detection sensor 133 may be an inductive sensor and/or a capacitance sensor.

The inductive sensor may include at least one coil. The coil of the inductive sensor may be arranged adjacent to the insertion space. For example, when a magnetic field changes around the coil through which a current flows, characteristics of the current flowing through the coil may change according to Faraday's law of electromagnetic induction. Here, the characteristics of the current flowing through the coil may include a frequency of an alternating current, a current value, a voltage value, an inductance value, an impedance value, and the like.

The inductive sensor may output a signal corresponding to the characteristics of the current flowing through the coil. For example, the inductive sensor may output a signal corresponding to an inductance value of the coil.

The capacitance sensor may include a conductor. The conductor of the capacitance sensor may be arranged adjacent to the insertion space. The capacitance sensor may output a signal corresponding to an ambient electromagnetic characteristic, e.g., a capacitance around the conductor. For example, when the stick S including a metal wrapper is inserted into the insertion space, the electromagnetic characteristic around the conductor may be changed by the wrapper of the stick S.

The reuse detection sensor 134 may detect whether or not the stick S is reused. The reuse detection sensor 134 may be a color sensor. The color sensor may detect a color of the stick S. The color sensor may detect a color of a portion of the wrapper wrapping the outside of the stick S. The color sensor may detect a value for an optical characteristic corresponding to a color of an object, on the basis of light reflected from the object. For example, the optical characteristic may be a wavelength of light. The color sensor may be implemented as a single component with a proximity sensor or may be implemented as a separate component distinguished from the proximity sensor.

At least a portion of the wrapper constituting the stick S may have a color changing by an aerosol. When the stick S is inserted into the insertion space, the reuse detection sensor 134 may be arranged in correspondence to a location at which at least the portion of the wrapper whose color changes by the aerosol is arranged. For example, before the stick S is used by the user, the color of at least the portion of the wrapper may be a first color. Here, when at least the portion of the wrapper is wetted by the aerosol while the aerosol generated by the aerosol generating device 1 passes through the stick S, the color of at least the portion of the wrapper may be changed to a second color. The color of at least the portion of the wrapper may be maintained in the second color after changing from the first color to the second color.

The cartridge detection sensor 135 may detect mounting and/or removal of the cartridge 19. The cartridge detection sensor 135 may be implemented by an inductance-based sensor, a capacitive sensor, a resistance sensor, a hall sensor (a hall IC) using a hall effect, or the like.

The cap detection sensor 136 may detect mounting and/or removal of a cap.

When the cap is detached from the body 10, a portion of the cartridge 19 and the body 10 covered by the cap may be exposed to the outside. The cap detection sensor 136 may be implemented by a contact sensor, a hall sensor (a hall IC), an optical sensor, or the like.

The motion detection sensor 137 may detect a motion of the aerosol generating device 1. The motion detection sensor 137 may be implemented as at least one of an acceleration sensor and a gyro sensor.

In addition to the sensors 131 to 137 described above, the sensor 13 may further include at least one of a humidity sensor, an atmospheric pressure sensor, a magnetic sensor, a position sensor (e.g., a global positioning system (GPS)), and a proximity sensor. Functions of the respective sensors may be intuitively inferred from names thereof by one of ordinary skill in the art, and thus, detailed descriptions thereof may be omitted.

The output unit 14 may output information regarding the state of the aerosol generating device 1 and provide the information to the user. The output unit 14 may include at least one of a display 141, a haptic unit 142, and a sound output unit 143, but is not limited thereto. When the display 141 and a touch pad form a layer structure to form a touch screen, the display 141 may be used as an input device in addition to an output device.

The display 141 may visually provide the user with information regarding the aerosol generating device 1. For example, the information regarding the aerosol generating device 1 may refer to various types of information such as a charging/discharging state of the power source 11 of the aerosol-generating device 1, a preheating state of the heater 18, the insertion/removal state of the stick S and/or the cartridge 19, the mounting/removal state of the cap, and the restriction on use of the aerosol generating device 1 (e.g., detection of an abnormal article), and the display 141 may output the information to the outside. For example, the display 141 may be in the form of a light emitting diode (LED) light emitting device. For example, the display 141 may be a liquid crystal display (LCD) panel, an organic light emitting display (OLED) panel, or the like.

The haptic unit 142 may tactilely provide the user with the information regarding the aerosol generating device 1 by converting an electrical signal into a mechanical stimulus or an electrical stimulus. For example, when initial power is supplied to the cartridge heater 24 and/or the heater 18 for a set time, the haptic unit 142 may generate vibration corresponding to completion of initial preheating. The haptic unit 142 may include a vibration motor, a piezoelectric element, or an electrical stimulation device.

The sound output unit 143 may audibly provide the user with the information regarding the aerosol generating device 1. For example, the sound output unit 143 may convert the electrical signal into a sound signal and output the sound signal to the outside.

The power supply 11 may supply power used to operate the aerosol generating device 1. The power source 11 may supply power so that the cartridge heater 24 and/or the heater 18 may be heated. In addition, the power source 11 may supply power needed for operations of the sensor 13, the output unit 14, the input unit 15, the communicator 16, and the memory 17, which are other components provided within the aerosol generating device 1. The power source 11 may be a rechargeable battery or a disposable battery. For example, the power supply 11 may be a lithium polymer (LiPoly) battery, but is not limited thereto.

Although not shown in FIG. 8, the aerosol generating device 1 may further include a power protection circuit. The power protection circuit may be electrically connected to the power source 11 and may include a switching element.

The power protection circuit may cut off an electrical path for the power source 11 according to a certain condition. For example, the power protection circuit may cut off the electrical path for the power source 11 when a voltage level of the power source 11 is a first voltage or more corresponding to overcharging. For example, the power protection circuit may cut off the electrical path for the power source 11 when the voltage level of the power source 11 is less than a second voltage corresponding to overdischarge.

The heater 18 may be supplied with power from the power source 11 and heat a medium or an aerosol generating material within the stick S. Although not shown in FIG. 8, the aerosol generating device 1 may further include a power conversion circuit (e.g., a DC/DC converter) that converts power of the power source 11 and supplies the converted power to the cartridge heater 24 and/or the heater 18. In addition, when the aerosol generating device 1 generates an aerosol by an induction heating method, the aerosol generating device 1 may further include a DC/AC converter that converts DC power of the power source 11 into AC power.

The controller 12, the sensor 13, the output unit 14, the input unit 15, the communicator 16, and the memory 17 may be supplied with power from the power source 11 to perform functions. Although not shown in FIG. 8, the aerosol generating device 1 may further include a power conversion circuit that converts power of the power source 11 and supplies the power to each of components, e.g., a low-dropout (LDO) circuit or a voltage regulator circuit. Also, although not shown in FIG. 8, a noise filter may be provided between the power source 11 and the heater 18. The noise filter may be a low pass filter. The low pass filter may include at least one inductor and a capacitor. A cutoff frequency of the low pass filter may correspond to a frequency of a high-frequency switching current applied from the power source 11 to the heater 18. The low pass filter may prevent a high-frequency noise component from being applied to the sensor 13, such as the insertion detection sensor 133.

In an embodiment, the cartridge heater 24 and/or the heater 18 may be formed of any suitable electrically resistive material. For example, the suitable electrically resistive material may be a metal or a metal alloy including titanium, zirconium, tantalum, platinum, nickel, cobalt, chromium, hafnium, niobium, molybdenum, tungsten, tin, gallium, manganese, iron, copper, stainless steel, or nichrome, but is not limited thereto. In addition, the heater 18 may be implemented by a metal wire, a metal plate on which an electrically conductive track is arranged, or a ceramic heating element, but is not limited thereto.

In an embodiment, the heater 18 may include an induction heater. For example, the heater 18 may include a susceptor that generates heat through a magnetic field applied by a coil to heat an aerosol generating material.

The input unit 15 may receive information input from the user or output the information to the user. For example, the input unit 15 may be a touch panel. The touch panel may include at least one touch sensor for detecting a touch. For example, the touch sensor may include a capacitive touch sensor, a resistive touch sensor, a surface acoustic touch sensor, an infrared touch sensor, or the like, but is not limited thereto.

The display 141 and the touch panel may be implemented as one panel. For example, the touch panel may be inserted into the display 141 (e.g., may be a on-cell type or in-cell type). For example, the touch panel may be added on the display 141 (e.g., may be an add-on type).

Meanwhile, the input unit 15 may include a button, a keypad, a dome switch, a jog wheel, a jog switch, or the like, but is not limited thereto.

The memory 17 may be hardware for storing various types of data processed within the aerosol generating device 1 and may store pieces of data processed by the controller 12 and pieces of data to be processed by the controller 12. The memory 17 may include at least one type of storage medium from among a flash memory type, a hard disk type, a multimedia card micro type, a card type memory (e.g., a SD or XD memory or the like), random access memory (RAM), static random access memory (SRAM), read-only memory (ROM), electrically erasable programmable read-only memory (EEPROM), programmable read-only memory (PROM), a magnetic memory, a magnetic disk, and an optical disk. The memory 17 may store data or the like regarding an operation time of the aerosol generating device 1, the maximum number of puffs, the current number of puffs, at least one temperature profile, and a smoking pattern of the user.

The communicator 16 may include at least one component for communication with another electronic device. For example, the communicator 16 may include at least one of a short-range wireless communication unit and a wireless communication unit.

The short-range wireless communication unit may include a Bluetooth communication unit, a Bluetooth low energy (BLE) communication unit, a near field communication unit, a wireless local area network ((WLAN) (Wi-Fi)) communication unit, a Zigbee communication unit, an infrared data association (IrDA) communication unit, a Wi-Fi Direct (WFD) communication unit, an ultra wideband (UWB) communication unit, an Ant+ communication unit, and the like, but is not limited thereto.

The wireless communication unit may include a cellular network communication unit, an Internet communication unit, a computer network (e.g., LAN or WAN) communication unit, and the like, but is not limited thereto.

Although not shown in FIG. 8, the aerosol generating device 1 may further include a connection interface such as a universal serial bus (USB) interface, and may connect with another external device through the connection interface such as a USB interface to transmit and receive information or charge the power 11.

The controller 12 may control an overall operation of the aerosol generating device 1. In an embodiment, the controller 12 may include at least one processor. The processor may be implemented as an array of a plurality of logic gates or may be implemented as a combination of a general-purpose microprocessor and a memory that stores a program executable by the microprocessor. In addition, one of ordinary skill in the art to which the present embodiment pertains may understand that the processor may be implemented as other types of hardware.

The controller 12 may control the temperature of the heater 18 by controlling supply power from the power source 11 to the heater 18. The controller 12 may control the temperature of the cartridge heater 24 and/or the heater 18 on the basis of the temperature of the cartridge heater 24 and/or the heater 18 sensed by the temperature sensor 131. The controller 12 may adjust power supplied to the cartridge heater 24 and/or the heater 18, on the basis of the temperature of the cartridge heater 24 and/or the heater 18. For example, the controller 12 may determine a target temperature for the cartridge heater 24 and/or the heater 18, on the basis of a temperature profile stored in the memory 17.

The aerosol generating device 1 may include a power supply circuit (not shown) electrically connected to the power source 11 between the power source 11 and the cartridge heater 24 and/or the heater 18. The power supply circuit may be electrically connected to the cartridge heater 24, the heater 18, or an induction coil. The power supply circuit may include at least one switching element. The switching element may be implemented by a bipolar junction transistor (BJT), a field effective transistor (FET), or the like. The controller 12 may control the power supply circuit.

The controller 12 may control power supply by controlling switching of the switching element of the power supply circuit. The power supply circuit may be an inverter that converts DC power output from the power source 11 into AC power. For example, the inverter may include a full-bridge circuit or a half-bridge circuit including a plurality of switching elements.

The controller 12 may turn on the switching element so that power is supplied from the power source 11 to the cartridge heater 24 and/or the heater 18. The controller 12 may turn off the switching element to cut off the supply of power to the cartridge heater 24 and/or the heater 18. The controller 12 may adjust a current supplied from the power source 11 by adjusting a frequency and/or duty ratio of a current pulse input into the switching element.

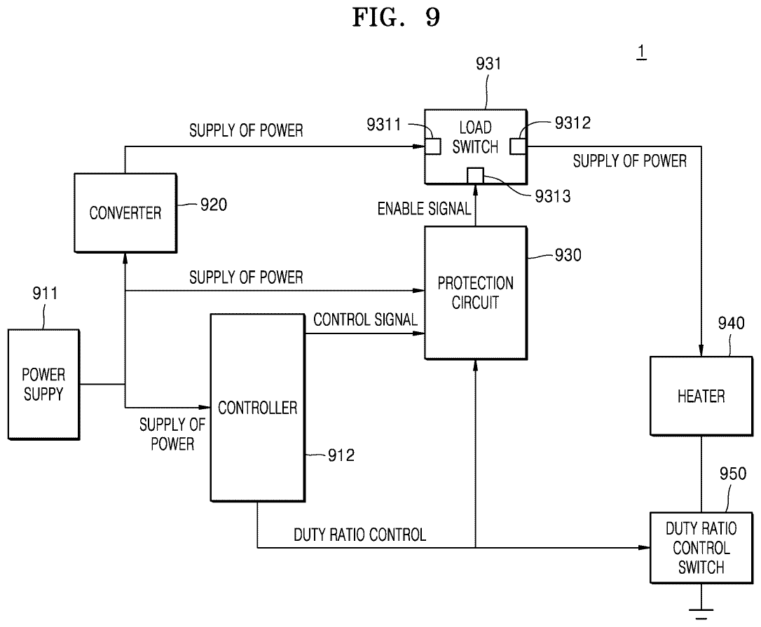

The controller 12 may control a voltage output from the power source 11 by controlling switching of the switching element of the power supply circuit. The power conversion circuit may convert the voltage output from the power source 11. For example, the power conversion circuit may include a buck-converter that steps down the voltage output from the power source 11. For example, the power conversion circuit may be implemented through a buck-boost converter, a Zener diode, or the like. Detailed contents of power supplied from the power supply 11 to the heater 18 or 24 will be described below with reference to FIG. 9.

The controller 12 may adjust a level of the voltage output from the power conversion circuit by controlling an on/off operation of the switching element included in the power conversion circuit. When the switching element continues to be turned on, the level of the voltage output from the power conversion circuit may correspond to a level of a voltage output from the power source 11. The duty ratio for the on/off operation of the switching element may correspond to a ratio of the voltage output from the power conversion circuit to the voltage output from the power source 11. The level of the voltage output from the power conversion circuit may decrease with a decrease in the duty ratio for the on/off operation of the switching element. The heater 18 may be heated on the basis of the voltage output from the power conversion circuit.

The controller 12 may control power to be supplied to the heater 18 by using at least one of a pulse width modulation (PWM) method and a proportional-integral-differential (PID) method.

For example, the controller 12 may control a current pulse having a certain frequency and duty ratio to be supplied to the heater 18 by using the PWM method. The controller 12 may control the power supplied to the heater 18 by adjusting the frequency and duty ratio of the current pulse.

For example, the controller 12 may determine a target temperature to be controlled, on the basis of the temperature profile. The controller 12 may control the power supplied to the heater 18 by using the PID method, which is a feedback control method through a difference value between the temperature of the heater 18 and the target temperature, a value obtained by integrating the difference value over time, and a value obtained by differentiating the difference value over time. More detailed contents of controlling of power supplied to the heater 18 or 24 by using the controller 12 will be described below with reference to FIG. 9.

The controller 12 may prevent the cartridge heater 24 and/or the heater 18 from overheating. For example, on the basis that the temperature of the cartridge heater 24 and/or the heater 18 exceeds a preset limit temperature, the controller 12 may control an operation of the power conversion circuit so that the supply of power to the cartridge heater 24 and/or the heater 18 stops. For example, on the basis that the temperature of the cartridge heater 24 and/or the heater 18 exceeds the preset limit temperature, the controller 12 may reduce an amount of power supplied to the cartridge heater 24 and/or the heater 18 by a certain ratio. For example, on the basis that the temperature of the cartridge heater 24 exceeds the preset limit temperature, the controller 12 may determine that the aerosol generating material accommodated in the cartridge 19 is exhausted and cut off the power supply to the cartridge heater 24.

The controller 12 may control charging and discharging of the power source 11. The controller 12 may identify the temperature of the power source 11 on the basis of an output signal of the temperature sensor 131.

When a power line is connected to a battery terminal of the aerosol generating device 1, the controller 12 may identify whether or not the temperature of the power source 11 is a first limit temperature or more which is a reference for blocking charging of the power source 11. When the temperature of the power source 11 is less than the first limit temperature, the controller 12 may control the power source 11 to be charged, on the basis of a preset charging current. The controller 12 may block charging of the power source 11 when the temperature of the power source 11 is the first limit temperature or more.

While the power of the aerosol generating device 1 is turned on, the controller 12 may identify whether or not the temperature of the power source 11 is a second limit temperature or more which is a reference for blocking discharge of the power source 11. The controller 12 may control power stored in the power source 11 to be used when the temperature of the power source 11 is less than the second limit temperature. When the temperature of the power source 11 is the second limit temperature or more, the controller 12 may stop using the power stored in the power source 11.

The controller 12 may calculate a remaining capacity of the power stored in the power source 11. For example, the controller 12 may calculate the remaining capacity of the power source 11 on the basis of a voltage and/or current sensing value of the power source 11.

The controller 12 may determine, through the insertion detection sensor 133, whether or not the stick S is inserted into the insertion space. The controller 12 may determine that the stick S is inserted, on the basis of the output signal of the insertion detection sensor 133. When determining that the stick S is inserted into the insertion space, the controller 12 may control power to be supplied to the cartridge heater 24 and/or the heater 18. For example, the controller 12 may supply power to the cartridge heater 24 and/or the heater 18, on the basis of the temperature profile stored in the memory 17.

The controller 12 may determine whether or not the stick S is removed from the insertion space. For example, the controller 12 may determine, through the insertion detection sensor 133, whether or not the stick S is removed from the insertion space. For example, when the temperature of the heater 18 is the preset limit temperature or more or when a temperature change gradient of the heater 18 is a set gradient, the controller 12 may determine that the stick S is removed from the insertion space. When determining that the stick S is removed from the insertion space, the controller 12 may cut off the supply of power to the cartridge heater 24 and/or the heater 18.

The controller 12 may control a power supply time and/or a power supply amount with respect to the heater 18, according to a state of the stick S detected by the sensor 13. The controller 12 may identify, on the basis of a look-up table, a level range including a level of a signal of the capacitance sensor. The controller 12 may determine an amount of moisture in the stick S, according to the identified level range.

When the stick S is over-humidified, the controller 12 may increase a preheating time of the stick S compared to a normal state by controlling the power supply time with respect to the heater 18.

The controller 12 may determine, through the reuse detection sensor 134, whether or not the stick S inserted into the insertion space is reused. For example, the controller 12 may compare a sensing value of a signal of the reuse detection sensor 134 with a first reference range including a first color and when the sensing value is included in the first reference range, determine that the stick S is not used. For example, the controller 12 may compare the sensing value of the signal of the reuse detection sensor 134 with a second reference range including a second color and when the sensing value is included in the second reference range, determine that the stick S is used. When determining that the stick S is used, the controller 12 may cut off the supply of power to the cartridge heater 24 and/or the heater 18.

The controller 12 may determine, through the cartridge detection sensor 135, whether or not the cartridge 19 is coupled and/or removed. For example, the controller 12 may determine whether or not the cartridge 19 is coupled or removed, on the basis of a sensing value of the signal of the cartridge detection sensor 135.

The controller 12 may determine whether or not the aerosol generating material of the cartridge 19 is exhausted. For example, the controller 12 may apply power to preheat the cartridge heater 24 and/or the heater 18, determine whether or not the temperature of the cartridge heater 24 exceeds the limit temperature in a preheating period, and when the temperature of the cartridge heater 24 exceeds the limit temperature, determine that the aerosol generating material of the cartridge 19 is exhausted. When determining that the aerosol generating material of the cartridge 19 is exhausted, the controller 12 may cut off the supply of power to the cartridge heater 24 and/or the heater 18.

The controller 12 may determine whether or not the cartridge 19 may be used. When the current number of puffs is greater than or equal to the maximum number of puffs set in the cartridge 19, the controller 12 may determine, on the basis of data stored in the memory 17, that the cartridge 19 may not be used. For example, when the total time for which the heater 24 is heated is a preset maximum time or more or the total amount of power supplied to the heater 24 is a preset maximum amount of power or more, the controller 12 may determine that the cartridge 19 may not be used.

The controller 12 may determine inhalation by the user through the puff sensor 132. For example, the controller 12 may determine whether or not a puff occurs, on the basis of a sensing value of a signal of the puff sensor 132. For example, the controller 12 may determine an intensity of the puff, on the basis of the sensing value of the signal of the puff sensor 132. When the number of puffs reaches the preset maximum number of puffs or when puffs are not detected for a preset time or more, the controller 12 may cut off the supply of power to the cartridge heater 24 and/or the heater 18.

The controller 12 may determine, through the cap detection sensor 136, whether a cap is coupled and/or removed. For example, the controller 12 may determine whether or not the cap is coupled and/or removed, on the basis of a sensing value of a signal of the cap detection sensor 136.

The controller 12 may control the output unit 14 on the basis of the result of detection by the sensor 13. For example, when the number of puffs counted through the puff sensor 132 reaches a preset number, the controller 12 may notify the user that the aerosol generating device 1 is soon terminated, through at least one of the display 141, the haptic unit 142, and the sound output unit 143. For example, the controller 12 may notify the user through the output unit 14 that the aerosol generating device 1 is soon terminated, on the basis of the determination that the stick S is not present in the insertion space. For example, the controller 12 may notify the user through the output unit 14 that the aerosol generating device 1 is soon terminated, on the basis of the determination that the cartridge 19 and/or the cap are not mounted. For example, the controller 12 may transmit information regarding the temperature of the cartridge heater 24 and/or the heater 18 to the user through the output unit 14.

The controller 12 may store and update, in the memory 17, a history of a certain event that occurs, on the basis of the occurrence of the event. The event may include detection of insertion of the stick S, initiation of heating of the stick S, detection of puffs, termination of the puffs, detection of overheating of the cartridge heater 24 and/or the heater 18, detection of application of an overvoltage to the cartridge heater 24 and/or the heater 18, termination of heating of the stick S, an operation such as power on/off of the aerosol generating device 1, initiation of charging of the power source 11, detection of overcharging of the power source 11, termination of charging of the power source 11, and the like. The history of the event may include a date and time when the event occurs, log data corresponding to the event, and the like. For example, when the certain event is the detection of insertion of the stick S, the log data corresponding to the event may include data regarding the sensing value of the insertion detection sensor 133 and the like. For example, when the certain event is the detection of overheating of the cartridge heater 24 and/or the heater 18, the log data corresponding to the event may include data regarding the temperature of the cartridge heater 24 and/or the heater 18, the voltage applied to the cartridge heater 24 and/or the heater 18, a current flowing through the cartridge heater 24 and/or the heater 18, and the like.

The controller 12 may control to form a communication link with an external device such as a mobile terminal of the user. When data regarding authentication is received from the external device through the communication link, the controller 12 may release a restriction on use of at least one function of the aerosol generating device 1. Here, the data regarding the authentication may include data indicating completion of user authentication for the user corresponding to the external device. The user may perform the user authentication through the external device. The external device may determine whether or not user data is valid, on the basis of the birthday of the user, a unique number indicating the user, and the like and receive, from an external server, data regarding use authority over the aerosol generating device 1. The external device may transmit the data indicating the completion of the user authentication to the aerosol generating device 1, on the basis of the data regarding the use authority. When the user authentication is completed, the controller 12 may release the restriction on the use of at least one function of the aerosol generating device 1. For example, when the user authentication is completed, the controller 12 may release a restriction on use of a heating function of supplying power to the heater 18.

The controller 12 may transmit data regarding the state of the aerosol generating device 1 to the external device through the communication link formed with the external device. On the basis of the received data regarding the state of the aerosol generating device 1, the external device may output the remaining capacity of the power source 11 of the aerosol generating device 1, an operation mode, and the like through a display of the external device.

The external device may transmit a location search request to the aerosol generating device 1, on the basis of an input for initiating a location search of the aerosol generating device 1. When receiving the location search request from the external device, the controller 12 may control at least one of output devices to perform an operation corresponding to the location search, on the basis of the received location search request. For example, the haptic unit 142 may generate vibration in response to the location search request. For example, the display 141 may output an object corresponding to the location search and an end of the search in response to the location search request.

When receiving firmware data from the external device, the controller 12 may control to perform a firmware update. The external device may identify a current version of firmware of the aerosol generating device 1 and determine whether or not a new version of the firmware is present. When an input for requesting firmware download is received, the external device may receive a new version of firmware data and transmit the new version of firmware data to the aerosol generating device 1. When receiving the new version of firmware data, the controller 12 may control the firmware update of the aerosol generating device 1 to be performed.

The controller 12 may transmit data regarding a sensing value of at least one sensor 13 to the external server (not shown) through the communicator 16, and receive from the server and store a learning model generated by learning the sensing value through machine learning such as deep learning. The controller 12 may perform an operation of determining an inhalation pattern of the user, an operation of generating a temperature profile, and the like by using the learning model received from the server. The controller 12 may store, in the memory 17, sensing value data of at least one sensor 13, data for training an artificial neural network (ANN), and the like. For example, the memory 17 may store a database for each component provided in the aerosol generating device 1, which is for training the ANN, and weights and biases constituting the structure of the ANN. The controller 12 may generate at least one learning model used for determining the inhalation pattern of the user, generating the temperature profile, and the like, by learning data regarding the sensing value of the at least one sensor 13, the inhalation pattern of the user, the temperature profile, and the like which are stored in the memory 17.

The load switch 31 may receive power from the power supply 11 and supply power to at least one heater 18 and 24. The protection circuit 30 may monitor electrical signals of the load switch 31 and control the load switch 31 based on the result of monitoring. The protection circuit 30 may receive control signals from the controller 12. The protection circuit 30 may receive a duty ratio of power supplied from the controller 12 to at least one heater 18 and 24. The load switch 31 and the protection circuit 30 will be described below in detail with reference to FIG. 9.

FIG. 9 is a block diagram for describing an operation of a protection circuit according to an embodiment.

An aerosol generating device according to an embodiment may include a power supply 911, a converter 920, a controller 912, at least one load switch 931, a protection circuit 930, at least one heater 940, and a duty ratio control switch 950. An embodiment is not limited to the configuration of FIG. 9, and a partial of configuration of FIG. 9 may be omitted, or a partial configuration of FIG. 8 may be added to FIG. 9, or the configuration of FIG. 9 may be combined with the configuration of FIG. 8.

The power supply 911 may supply power required to operate the aerosol generating device 1.

The power supply 911 may supply power to the controller 912, the protection circuit 930, and the load switch 931. It may be understood by those skilled in the art that other general components in addition to the components shown in FIG. 9 may be supplied from power supply 911.

The controller 912 may control the overall operation of the aerosol generating device.

The controller 912 may control an amount of power supplied to the heater 940. In an embodiment, the controller 912 may control a duty ratio of power supplied to the heater 940 by using a proportion, integration, differentiation (PID) control method. The PID control method may be a control method, by which a proportion control (P control), integration control (I control) and differentiation control (D control) are combined with each other.

The P control may be a control method, by which feedback is performed by multiplying a difference with a target value by a gain that is a constant. The P control may be performed in a sloshing form as much as a deviation based on the target value. By performing a control operation by multiplying a gain using the P control, it may be quickly close to the target value. However, when only the P control may not properly follow the target value, like in a secondary system, the I control and/or the D control method may be added.

The I control may be a control method, by which feedback is performed by integrating errors. That is, the I control may be a control method, by which errors are accumulated and are reflected in a next round. In the P control, when the value in a greatly-sloshing form is performed in the PI control, an overshoot may be gradually reduced, and the target value may be followed. On the other hand, when only the PI control is performed, the value in an arithmetically finely sloshing form is present as a residual deviation, and a measurement value may vibrate for a considerable amount of time due to the residual deviation.

The D control may be a control method, by which errors are differentiated and feedback is performed to a control system. By adding the D control to the PI control, differentiation is applied in a proportional and integrated graph form, and the residual deviation may be removed, so that a vibrating system may be controlled to follow the target value without errors within an appropriate time.

In another embodiment, the controller 912 may control a duty ratio of power supplied to the heater 940 by using a pulse width modulation (PWM) control method. The controller 912 may supply power to the heater 940 based on a preset duty ratio. The controller 912 may transmit duty ratio control signals to the duty ratio control switch 950. In this case, the controller 912 may also transmit the duty ratio control signals to the protection circuit 930.

The protection circuit 930 may monitor electrical signals of the load switch 931 and control the load switch 931 based on the result of monitoring, thereby preventing an abnormal operation of the load switch 931. In FIGS. 8 and 9, the protection circuit 930 and the controller 912 are illustrated as separate components, but this is an example for convenience of explanation, and the protection circuit 930 and the controller 912 may also be implemented in one integrated circuit (IC). In an embodiment, the protection circuit 930 may be implemented as separate hardware from the controller 912, and the protection circuit 930 may be implemented as a field programmable gate array (FPGA).

The load switch 931 may receive power from the power supply 911. The load switch 931 may receive enable signals from the protection circuit 930. The load switch 931 may transmit power, which is received from the power supply 911, to the heater 940. The load switch 931 may include a first terminal 9311 electrically connected to the power supply 911, a second terminal 9312 electrically connected to a heater, and a third terminal 9313 that receives enable signals turning on/off an electrical connection between the first terminal 9311 and the second terminal 9312. When receiving a first enable signal from the third terminal 9313, the load switch 931 may turn off an electrical connection between the first terminal 9311 and the second terminal 9312. When receiving a second enable signal from the third terminal 9313, the load switch 931 may turn on an electrical connection between the first terminal 9311 and the second terminal 9312. When the load switch 931 is turned on, power may be supplied to the heater 940, and when the load switch 931 is turned off, the supply of power to the heater 940 may be cut off. The first enable signal may have a logic low value, and the second enable signal may have a logic high value.

The load switch 931 may have a limitation in power that may be transmitted through the first terminal 9311 and the second terminal 9312. Specifically, the load switch 931 may have a maximum current Imax, which is a limit of a size of a current flowing through the first terminal 9311 and the second terminal 9312. In addition, the load switch 931 may have a maximum input voltage Vmax, which is a limit of a magnitude of a voltage applied to the first terminal 9311. When the voltage applied to the load switch 931 and the current exceed a maximum current or a maximum input voltage, a semiconductor device, such as a FET that constitutes the load switch 931, may be damaged so that a normal on/off operation according to the first and second enable signals may not be performed. When the load switch 931 is damaged and a normal operation is not performed, the heater 940 may malfunction, and user satisfaction with smoking may decrease, and further, the aerosol generating device 1 may be damaged. Thus, a technology for preventing damage of the load switch 931 is required.

The protection circuit 930 may monitor electrical signals of the load switch 931. The protection circuit 930 may output enable signals to the third terminal 9313 of the protection circuit 930 based on the result of monitoring the load switch 931.

In an embodiment, when a current flowing through the first terminal 9311 and the second terminal 9312 of the load switch 931 exceeds a first threshold value, the protection circuit 930 may output the first enable signal, thereby turning off an electrical connection between the first terminal 9311 and the second terminal 9312 of the load switch 931. The first threshold value may be a value that is less than the maximum current Imax as described above.

In an embodiment, when a voltage applied to the first terminal 9311 of the load switch 931 exceeds a second threshold value, the protection circuit 9310 may output the first enable signal, thereby turning off an electrical connection between the first terminal 9311 and the second terminal 9312 of the load switch 931. The second threshold value may be a value that is less than the maximum input voltage Vmax as described above.

In an embodiment, the protection circuit 930 may prevent an abnormal operation of the heater 940 based on an operation duration of the heater 940. Specifically, when a turn-on duration of the load switch 931 exceeds a third threshold value, the protection circuit 9310 may output the first enable signal, thereby turning off an electrical connection between the first terminal 9311 and the second terminal 9312 of the load switch 931. The third threshold value may be 4 minutes or 5 minutes. The aerosol generating device 1 may set a heating operation time of the heater 940 in advance in consideration of the type of the inserted stick or cartridge or smoking environment. The turn-on duration of the load switch 931 exceeds the heating operation time of the pre-set heater 940 may be the case where an error occurs in a heating operation time control algorithm of the heater 940. When the error occurs in the heating operation time control algorithm of the heater 940, damage of the aerosol generating device 1 may occur. When the turn-on duration of the load switch 931 exceeds a third threshold value, an electrical connection between the first terminal 9311 and the second terminal 9312 of the load switch 931 may be turned off, so that damage of the aerosol generating device 1 may be prevented.

In another embodiment, the protection circuit 930 may prevent an abnormal operation of the heater 940 based on a duty ratio of power supplied to the heater 940. Specifically, the protection circuit 930 may receive a duty ratio of power supplied from the controller 912 to the heater 940, and when the duty ratio is maintained as the same value for a certain time, the protection circuit 930 may output the first enable signal and turn off an electrical connection between the first terminal 9311 and the second terminal 9312 of the load switch 931. For example, the certain time may be 5 seconds, 10 seconds, 15 seconds, or the like, but embodiments are not limited thereto. The duty ratio of power supplied to the heater 940 is maintained as the same value for a certain time may be the case where an error occurs in a duty ratio control algorithm of the controller 912. The controller 912 may control power supplied to the heater 940 according to the PID control method. When the same duty ratio is supplied to the heater 940 for a certain time, user satisfaction with smoking may decrease, or damage of the aerosol generating device 1 may occur.

The first through third threshold values and the certain time may be stored in a memory (e.g., the memory 17 of FIG. 8) in advance.

In an embodiment, the controller 912 may receive the first and second enable signals, which are output by the protection circuit 930. When the protection circuit 930 outputs the first enable signal, the controller 912 may notify, through the output unit (e.g., the output unit 14 of FIG. 8), that the aerosol generating device is in a temporary stop state. The output unit may notify that the aerosol generating device is in a temporary stop state, by using at least one method of a visual method, a tactile method, and an auditory method.

In an embodiment, the controller 912 may detect re-insertion of the stick through the insertion detection sensor (e.g., the insertion detection sensor 133 of FIG. 8). The controller 912 may control the protection circuit 930 to output the second enable signal when re-insertion of the stick to the insertion space is detected. The second enable signal output by the protection circuit 930 may be output to the third terminal of the load switch 931, so that an electrical connection between the first terminal and the second terminal of the load switch 931 may be turned on. As a result, when re-insertion of the stick is detected, the controller 912 may supply power to the heater 940 again so that the aerosol generating device may operate. When the protection circuit 930 outputs the second enable signal, the controller 912 may notify, through the output unit (e.g., the output unit 14 of FIG. 8), that the aerosol generating device is in a heating operation state. The output unit may notify that the aerosol generating device is in a heating operation state, by using at least one method of a visual method, a tactile method, and an auditory method.

The converter 920 may supply power supplied from the power supply 911 to the heater 940 by using the load switch 931. The converter 920 may control a level of a voltage output from the power supply 911 and supply power to the heater 940. The converter 920 may be implemented with a Buck-boost converter, a Zener diode, etc.

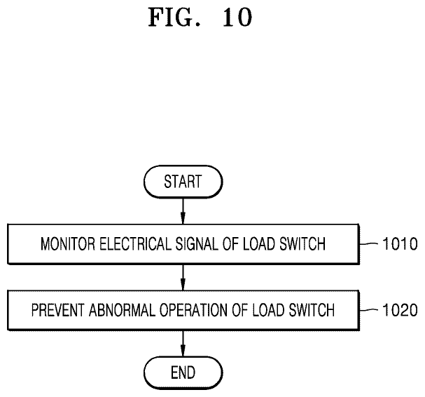

FIG. 10 is a flowchart illustrating a method of controlling an aerosol generating device, according to an embodiment.

Referring to FIGS. 8 through 10, in operation 1010, the protection circuit 930 may monitor electrical signals of the load switch 931.

In an embodiment, the protection circuit 930 may measure a current flowing through the first terminal 9311 and the second terminal 9312 of the load switch 931 and compare the current flowing through the first terminal 9311 and the second terminal 9312 with a first threshold value. The first threshold value may be a value that is less than Imax, which is a maximum limit of a size of a current flowing through the first terminal 9311 and the second terminal 9312 of the load switch 931.

In an embodiment, the protection circuit 930 may measure a voltage applied to the first terminal 9311 of the load switch 931 and compare the voltage applied to the first terminal 9311 with a second threshold value. The second threshold value may be a value that is less than Vmax, which is a maximum limit of a magnitude of a voltage applied to the first terminal 9311 of the load switch 931.

In an embodiment, the protection circuit 930 may measure a turn-on duration of the load switch 931 and compare the turn-on duration with the third threshold value. The third threshold value may be 4 minutes or 5 minutes.

In operation 1020, the protection circuit 930 may prevent an abnormal operation of the load switch 931. Specifically, the protection circuit 930 may output enable signals to the third terminal 9313 of the protection circuit 930 based on the result of monitoring the load switch 931.

In an embodiment, when a current flowing through the first terminal 9311 and the second terminal 9312 of the load switch 931 exceeds the first threshold value, the protection circuit 930 may output the first enable signal and turn off an electrical connection between the first terminal 9311 and the second terminal 9312 of the load switch 931.

In an embodiment, when a voltage applied to the first terminal 9311 of the load switch 931 exceeds the second threshold value, the protection circuit 9310 may output the first enable signal and turn off an electrical connection between the first terminal 9311 and the second terminal 9312 of the load switch 931.

In an embodiment, when a turn-on duration of the load switch 931 exceeds the third threshold value, the protection circuit 930 may output the first enable signal and turn off an electrical connection between the first terminal 9311 and the second terminal 9312 of the load switch 931.

In another embodiment, the protection circuit 930 may prevent an abnormal operation of the heater 940 based on a duty ratio of power supplied to the heater 940. Specifically, the protection circuit 30 may receive the duty ratio of power supplied from the controller 912 to the heater 940. When the duty ratio is maintained as the same value for a certain time, the protection circuit 930 may output the first enable signal and turn off an electrical connection between the first terminal 9311 and the second terminal 9312 of the load switch 931.

As described above, an aerosol generating device according to an embodiment can prevent malfunction of a heater.

Any embodiment or other embodiments described above are not exclusive or distinct from each other. Some embodiments or other embodiments described above may be combined or combined with each configuration or function.

For example, it means that the A configuration described in a specific embodiment and/or the drawings and the B configuration described in another embodiment and/or the drawings may be combined with each other. In other words, even if it is not explained directly about combination between the configurations, it is possible to combine unless it is explained that combination is impossible.

The detailed description of the above should not be interpreted in all aspects and should be considered as exemplary. The scope of the disclosure should be determined by a rational interpretation of the attached claims, and all changes within the equivalent scope of the disclosure are included in the scope of the invention.

An aerosol generating device according to an embodiment can prevent malfunction of a heater.

What is claimed is:

1. An aerosol generating device comprising:
at least one heater configured to heat an aerosol generating material;
a power supply configured to supply power to the at least one heater;
a load switch comprising a first terminal electrically connected to the power supply, a second terminal electrically connected to the at least one heater, and a third terminal configured to receive an enable signal turning on or off an electrical connection between the first terminal and the second terminal;
a controller configured to control power supplied to the heater; and
a protection circuit configured to monitor an electrical signal of the load switch and to output the enable signal to the third terminal.

2. The aerosol generating device of claim 1, wherein the protection circuit is further configured to output a first enable signal turning off an electrical connection between the first terminal and the second terminal when a current flowing through the first terminal and the second terminal exceeds a first threshold value.

3. The aerosol generating device of claim 1, wherein the protection circuit is further configured to output a first enable signal turning off an electrical connection between the first terminal and the second terminal when a voltage applied the first terminal exceeds a second threshold value.

4. The aerosol generating device of claim 1, wherein the protection circuit is further configured to output a first enable signal turning off an electrical connection between the first terminal and the second terminal when a turn-on duration of the load switch exceeds a third threshold value.

5. The aerosol generating device of claim 1, wherein the protection circuit is further configured to receive a duty ratio of power supplied to the heater from the controller and output a first enable signal turning off an electrical connection between the first terminal and the second terminal when the duty ratio is maintained as a same value for a certain time.

6. The aerosol generating device of one of claim 2, further comprising an output unit configured to output information about a state of the aerosol generating device, wherein the controller is further configured to notify, through the output unit, that the aerosol generating device is in a temporary stop state, when the protection circuit outputs the first enable signal.

7. The aerosol generating device of claim 6, wherein the output unit is configured to provide information to a user by using at least one method of a visual method, a tactile method, and an auditory method.

8. The aerosol generating device of claim 2, further comprising an insertion detection sensor configured to detect whether a stick is inserted into an insertion space, wherein the controller is further configured to control the protection circuit to output a second enable signal turning on an electrical connection between the first terminal and the second terminal, when re-insertion of the stick to the insertion space is detected.

9. The aerosol generating device of claim 8, wherein the insertion detection sensor is configured to detect whether the stick is inserted, based on a dielectric constant change inside the insertion space.

10. The aerosol generating device of claim 5, wherein the controller is further configured to control power supplied to the heater by using a proportion, integration, differentiation (PID) method.

11. A method of controlling an aerosol generating device, the method comprising:
monitoring an electrical signal of a load switch comprising a first terminal electrically connected to a power supply, a second terminal electrically connected to a heater, and a third terminal configured to receive an enable signal turning on or off an electrical connection between the first terminal and the second terminal, and configured to transmit power supplied from the power supply to the heater; and
preventing an abnormal operation of the load switch.

12. The method of claim 11, wherein the monitoring comprises:
measuring a current flowing through the first terminal and the second terminal; and
comparing the current with a first threshold value, and
the preventing comprises turning off an electrical connection between the first terminal and the second terminal, when the current exceeds the first threshold value.

13. The method of claim 11, wherein the monitoring comprises:
measuring a voltage applied to the first terminal; and
comparing the voltage with a second threshold value, and
the preventing comprises turning off an electrical connection between the first terminal and the second terminal, when the voltage exceeds the second threshold value.

14. The method of claim 11, wherein the monitoring comprises:
measuring a turn-on duration of the load switch; and
comparing the turn-on duration with a third threshold value, and
the preventing comprises turning off an electrical connection between the first terminal and the second terminal, when the turn-on duration exceeds the third threshold value.

15. The method of claim 11, further comprising receiving a duty ratio of power supplied to the heater, wherein the preventing comprises turning off an electrical connection between the first terminal and the second terminal, when the duty ratio is maintained as a same value for a certain time.
